(19) United States
(12) Patent Application Publication
(10) Pub. No.: US 2024/0373227 A1
(43) Pub. Date: Nov. 7, 2024

(54) MALICIOUS COMMUNICATION DETECTION DEVICE, COMMUNICATION PERMISSION LIST GENERATION DEVICE, MALICIOUS COMMUNICATION DETECTION METHOD, COMMUNICATION PERMISSION LIST GENERATION METHOD, STORAGE MEDIUM STORING MALICIOUS COMMUNICATION DETECTION PROGRAM, AND STORAGE MEDIUM STORING COMMUNICATION PERMISSION LIST GENERATION PROGRAM

(71) Applicant: Mitsubishi Electric Corporation, Tokyo (JP)

(72) Inventor: Masamichi TANJI, Tokyo (JP)

(73) Assignee: Mitsubishi Electric Corporation, Tokyo (JP)

(21) Appl. No.: 18/778,512

(22) Filed: Jul. 19, 2024

Related U.S. Application Data
(63) Continuation of application No. PCT/JP2022/010920, filed on Mar. 11, 2022.

(51) Int. Cl. H04W 12/12; H04W 12/61

(52) U.S. Cl. CPC H04W 12/12; H04W 12/61

(57) ABSTRACT

An objective is to obtain a malicious communication detection device that can more accurately determine whether a communication message is a normal message. The malicious communication detection device according to the present disclosure includes a communication acquisition unit to acquire a communication message, and a communication assessment unit to determine whether the communication message is a normal message on the basis of a periodicity requirement set for each time-varying state of the communication message.

### CROSS REFERENCE TO RELATED APPLICATION

This application is a Continuation of PCT International Application No. PCT/JP2022/010920, filed on Mar. 11, 2022, which is hereby expressly incorporated by reference into the present application.

### TECHNICAL FIELD

The present disclosure relates to a malicious communication detection device, a communication permission list generation device, a malicious communication detection method, a communication permission list generation method, a malicious communication detection program, and a communication permission list generation program.

### BACKGROUND TECHNOLOGY

In recent years, research and other studies have revealed attacks that deceive control of an Internet of Things (IoT) system by transmitting a malicious message impersonating messages flowing in the IoT network from an unauthorized device connected within the IoT system.

For this reason, there is a growing trend to incorporate a malicious communication detection function for monitoring the messages flowing in the network to detect a malicious message. In a system including many routine and cyclic messages flowing in the network, it is effective to apply a permitted-list-type malicious communication detection function, in which information about such normal messages is maintained as the permitted list, and a message deviating from the list is detected as a malicious message. The permitted-list-type malicious communication detection function also has an advantage of not having to update the list as frequently as a denied-list-type malicious communication detection function, which maintains information about the malicious messages.

When the malicious communication detection function performs detection on the basis of a periodicity requirement, in other words, when the malicious communication detection function detects a message characterized by periodicity as a malicious message if the message deviates from a normal period, it is necessary to set a reasonable period range (upper and lower limits for the period to be considered normal) as the periodicity requirement, taking into account a periodic error such as delay, early arrival, etc., that may normally occur in the network. If the set periodicity requirement is too narrow, the possibility of false positives for judging normal messages as malicious message increases. On the other hand, if it is too wide, the possibility of false negatives for not detecting malicious messages increases.

Therefore, Patent Document 1 proposes a method for learning and analyzing communication data to determine a periodicity requirement.

### PRIOR ART REFERENCES

### [Patent Documents]

[Patent Document 1] Japanese Patent Application Publication No. 2021-048495

### SUMMARY OF THE INVENTION

### Problems to be Solved by the Invention

The method disclosed in Patent Document 1 generates the periodicity requirement that includes the worst case of periodic error occurring within the communication data to reduce the occurrence of false detection. However, some periodic messages contain characteristic variations in the periodic errors due to the network environment and constraints of applications that transmit periodic messages. Therefore, simply considering the worst case of periodic error in the communication data is not enough to determine whether a message is a normal message or a malicious message.

The present disclosure is designed to solve the above problem and to obtain a malicious communication detection device that can more accurately determine whether a communication message is a normal message or not.

### Means for Solving the Problem

An aspect of the malicious communication detection device according to the present disclosure includes: a communication acquisition unit to acquire a communication message; and a communication assessment unit to determine whether the communication message is a normal message on the basis of a periodicity requirement set for each time-varying state of the communication message, wherein the communication assessment unit identifies the periodicity requirement of the communication message on the basis of a state of the communication message classified according to a transition type which is a factor affecting a periodic error of the communication message and a plurality of transition conditions which is set for each transition type, and determines whether the communication message is a normal message.

An aspect of the malicious communication detection device according to the present disclosure includes: a communication acquisition unit to acquire a communication message; and a communication assessment unit to determine whether the communication message is a normal message on the basis of a periodicity requirement set for each time-varying state of the communication message, wherein the communication assessment unit identifies the state of the communication message on the basis of at least one of a bandwidth load, a transmission count, and a time interval, and determines whether the communication message is a normal message according to the periodicity requirement set for the identified state of the communication message.

### Effects of the Invention

The malicious communication detection device according to the present disclosure includes the communication assessment unit to determine whether a communication message is a normal message or not on the basis of the periodicity requirement set for each time-varying state. This allows for more accurate determination of whether a communication message is a normal message or not by performing the determination of the communication message on the basis of the periodicity requirement for each time-varying state.

### BRIEF DESCRIPTION OF FIGURES

FIG. 1 is a configuration diagram showing a configuration of a vehicle system 10 according to Embodiment 1.

FIG. 2 is a configuration diagram showing a configuration of a GW 11 and a malicious communication detection device 100 according to Embodiment 1.

FIG. 3 is a conceptual diagram showing a specific example of a message format of a communication message.

FIG. 4 is a conceptual diagram showing a specific example of a format of a rule list 122.

FIG. 5 is a conceptual diagram showing a specific example of a format of a periodicity requirement list 123.

FIG. 6 is a conceptual diagram showing a specific example of a format of a periodicity requirement list 124.

FIG. 7 is a conceptual diagram showing a specific example of a format of a periodicity requirement list 125.

FIG. 8 is a conceptual diagram showing a specific example of a format of a periodicity requirement list 126.

FIG. 9 is a hardware configuration diagram showing a hardware configuration of the malicious communication detection device 100 according to Embodiment 1.

FIG. 10 is a flowchart showing an operation of the malicious communication detection device 100 according to Embodiment 1.

FIG. 11 is a configuration diagram of a configuration of a communication permission list generation device 200 according to Embodiment 1.

FIG. 12 is a flow diagram illustrating an internal operation and input/output information of a processing unit 210 according to Embodiment 1.

FIG. 13 is a conceptual diagram showing a specific example of a format of a communication specification 221.

FIG. 14 is a conceptual diagram showing a specific example of a format of a communication data 222.

FIG. 15 is a conceptual diagram showing a specific example of a format of a communication data 223.

FIG. 16 is a hardware configuration diagram showing a hardware configuration of the communication permission list generation device 200 according to Embodiment 1.

FIG. 17 is a flowchart showing a communication specification analysis process performed by a communication specification analysis unit 211 according to Embodiment 1.

FIG. 18 is a flowchart showing a message information analysis subroutine performed by the communication specification analysis unit 211 according to Embodiment 1.

FIG. 19 is a flowchart showing a signal information analysis subroutine performed by the communication specification analysis unit 211 according to Embodiment 1.

FIG. 20 is a conceptual diagram showing a specific example of an internally generated file 301.

FIG. 21 is a conceptual diagram showing a specific example of an internally generated file 302.

FIG. 22 is a conceptual diagram showing a specific example of an internally generated file 303.

FIG. 23 is a conceptual diagram showing a specific example of an internally generated file 304.

FIG. 24 is a conceptual diagram showing a specific example of an internally generated file 305.

FIG. 25 is a flowchart showing a communication permission list output process performed by a communication permission list output unit 212 according to Embodiment 1.

FIG. 26 is a flowchart showing a communication data analysis process performed by a communication data analysis unit according to Embodiment 1.

### EMBODIMENTS FOR CARRYING OUT THE INVENTION

### Embodiment 1

The present disclosure first describes a malicious communication detection phase in which malicious communication detection is performed on the basis of a communication permission list, and then describes a communication permission list generation phase in which the communication permission list is generated. The malicious communication detection device described in a section of the malicious communication detection phase and the communication permission list generation device described in a section of the communication permission list generation phase together form a communication system.

### (Malicious Communication Detection Phase)

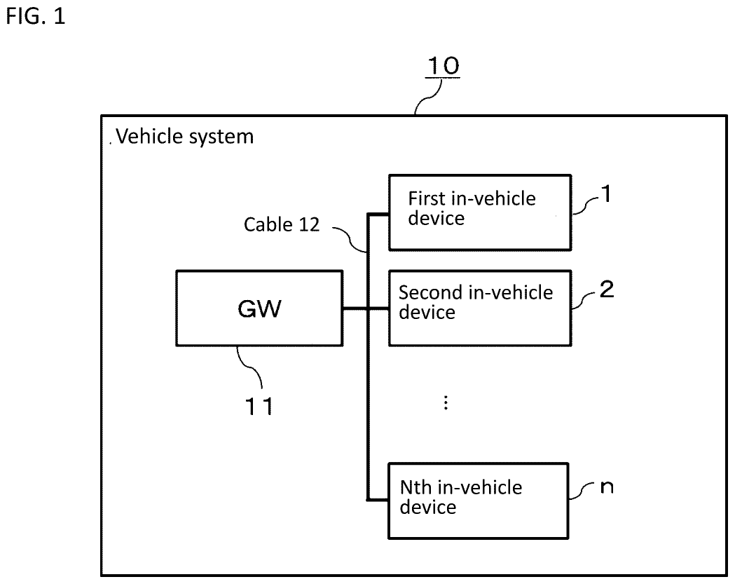

FIG. 1 is a configuration diagram showing a configuration of a vehicle system 10 according to Embodiment 1.

The vehicle system 10 includes a GW (gateway) 11, a cable 12, a first in-vehicle device 1, a second in-vehicle device 2, . . . and an nth in-vehicle device n. N is an integer larger than or equal to one, and real vehicles include several tens to one hundred and several tens of in-vehicle devices.

The GW 11, the first in-vehicle device 1, the second in-vehicle device 2, . . . the nth in-vehicle device n communicate with each other via the cable 12. The cable 12 is a cable that supports Controller Area Network (CAN) communication, which is a standard for communication in a vehicle. Because CAN allows broadcast communication, the GW 11 can receive all communication flowing through the cable 12.

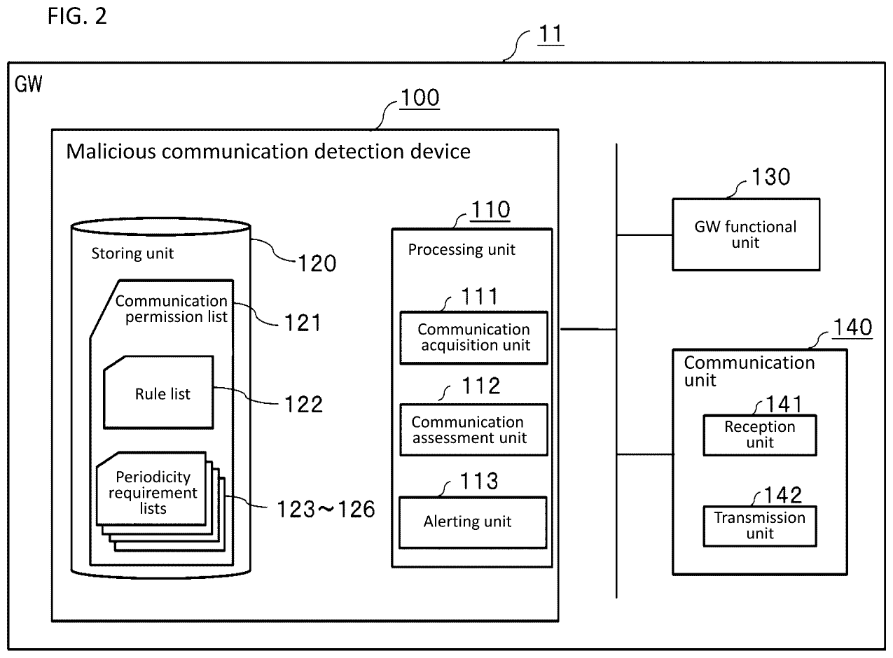

FIG. 2 is a configuration diagram showing a configuration of the GW 11 and a malicious communication detection device 100. The GW 11 includes the malicious communication detection device 100, a GW functional unit 130, and a communication unit 140. In the following, the term “unit” means an element of a functional configuration, and the term “unit” may be read as “process” or “step,” as appropriate. The operation of the malicious communication detection device 100 corresponds to a malicious communication detection method, and the program that causes a computer to execute the malicious communication detection method corresponds to a malicious communication detection program.

The GW functional unit 130 transfers communication messages.

The communication unit 140 performs data communication. The communication unit 140 includes a reception unit 141 that receives data, and a transmission unit 142 that transmits data. The reception unit 141 has a function to monitor a bandwidth load state of the cable 12 by counting the number of communication messages received per unit of time.

The malicious communication detection device 100 performs fraud detection on the communication messages flowing in the vehicle system 10, and includes a processing unit 110 and a storing unit 120.

The processing unit 110 includes a communication acquisition unit 111, a communication assessment unit 112, and an alerting unit 113.

The communication acquisition unit 111 acquires the communication messages. In Embodiment 1, the communication acquisition unit 111 acquires the communication messages received by the reception unit 141 together with reception time information in the reception unit 141 and transmits them to the communication assessment unit 112.

The communication assessment unit 112 determines whether a communication message is a normal message or not on the basis of the periodicity requirement set for each time-varying state of the communication message. The state of the communication message indicates a characteristic of the communication message that affects the periodic error. In Embodiment 1, the state of the communication message is classified on the basis of a transition type, which is a factor that affects the periodic error, and a plurality of transition conditions set for each transition type. That is, the communication assessment unit 112 identifies the periodicity requirement of the communication message on the basis of the state of the communication message classified on the basis of the transition type and the transition conditions to determine whether the communication message is a normal message or not.

As for the state of the communication message, more specifically, the characteristics that affect the periodic errors of the communication messages are broken down into a plurality of transition states, such as bandwidth load, transmission count, and time interval, and then each of these items is further broken down into a plurality of items, which are set as transition conditions. Details of the transition states and the transition conditions will be described later.

In Embodiment 1, the communication assessment unit 112 determines whether the communication message is a normal message or not by referring to a periodicity requirement list in which the periodicity requirement is set for each state of the communication message. More specifically, the communication assessment unit 112 determines whether the communication message is a normal message or not by determining whether a receiving period of a communication message deviates from a period range defined in the periodicity requirement list to be described later.

In Embodiment 1, the communication assessment unit 112 identifies the periodicity requirement of the communication message on the basis of the transition type, which is a factor affecting the periodic error of the communication message, and the state of the communication message, which is classified on the basis of the plurality of transition conditions set for each transition type, to determine whether the communication message is a normal message or not.

The transition type here is, for example, bandwidth load, transmission count, and time interval. In Embodiment 1, the communication assessment unit 112 identifies the state of the communication message on the basis of at least one of the bandwidth load, the transmission count, and the time interval to determine whether the communication message is a normal message or not on the basis of the periodicity requirement set for the identified state of the communication message.

The alerting unit 113 alerts a user when the communication assessment unit 112 determines that a communication message is not a normal message.

The storing unit 120 stores various information, especially a communication permission list 121. The communication permission list 121 provides rules for the malicious communication detection, and includes a rule list 122 and periodicity requirement lists 123 to 126. That is, in Embodiment 1, the storing unit 120 stores the plurality of periodicity requirement lists 123 to 126 and the rule list 122 as the communication permission list 121. The rule list 122 associates an ID contained in the communication message to a periodicity requirement ID indicating a type of the periodicity requirement list.

The periodicity requirement lists 123 to 126 are lists that specify the periodicity requirement for each state of the communication message. More specifically, the periodicity requirement list maintains a normal period range of each state of the communication message as the periodicity requirement.

In Embodiment 1, four lists, namely the periodicity requirement lists 123 to 126, are assumed as the periodicity requirement list, but the number of periodicity requirement lists is not limited to this number as long as there is at least one. Details of the rule list 122 and the periodicity requirement lists 123 to 126 will be described later. The communication permission list 121 is stored in a non-volatile storage device and loaded into a memory from the non-volatile storage device when the GW 11 is activated. In addition, but not shown herein, the storing unit 120 stores data used, generated, inputted, outputted, transmitted, or received by the GW 11.

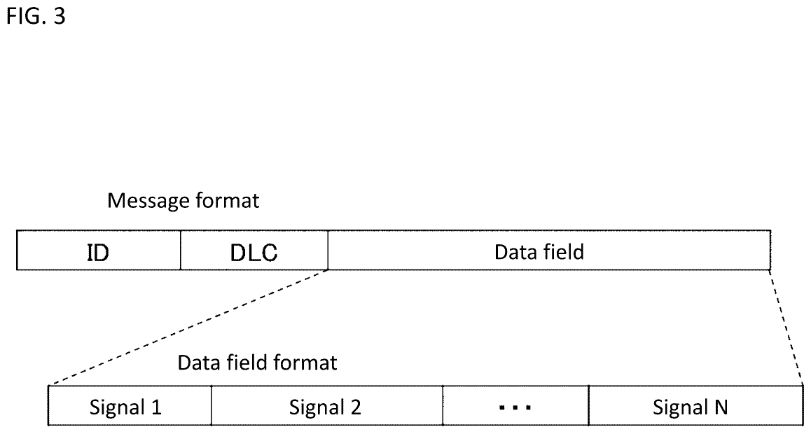

FIG. 3 shows a message format of a CAN communication message flowing in the vehicle system 10, which is a detection target of the malicious communication detection device 100. The CAN communication message contains an ID, a DLC, and a data field. ID is a message number assigned to uniquely identify the communication message. DLC (Data Length Code) indicates a data length of the following data field in bytes. The data field is a field containing data used by an application, and the maximum length of this field is 8 bytes for CAN communication. The data field includes a number of signals. A signal can take 1 to 64-bit data length. ID, DLC, the data field, and the details of each signal are defined for each vehicle system 10.

Among the CAN communication messages, there are many periodic messages that are transmitted on a regular basis with a predetermined period for each message. In reality, however, the period is not always accurately maintained, and errors such as early arrival and delay occur as affected by various factors.

When observing the communication performed in the network of a real vehicle, some of these periodic messages are found characteristic in the transitions of the periodic errors. For example, a periodic message with a short period, such as 10 ms, is more easily affected by the bandwidth load on a CAN cable and thus tends to have a longer transmission delay at high load, resulting in a larger periodic error. As another example, some of the periodic messages repeat a large periodic error with a constant timing in terms of transmission count, time interval, or the like. These are presumably due to the influence of an in-vehicle device or an application on the in-vehicle device, etc. transmitting such periodic messages. The present disclosure relates to a method of setting the periodicity requirements for the periodic messages having these characteristics.

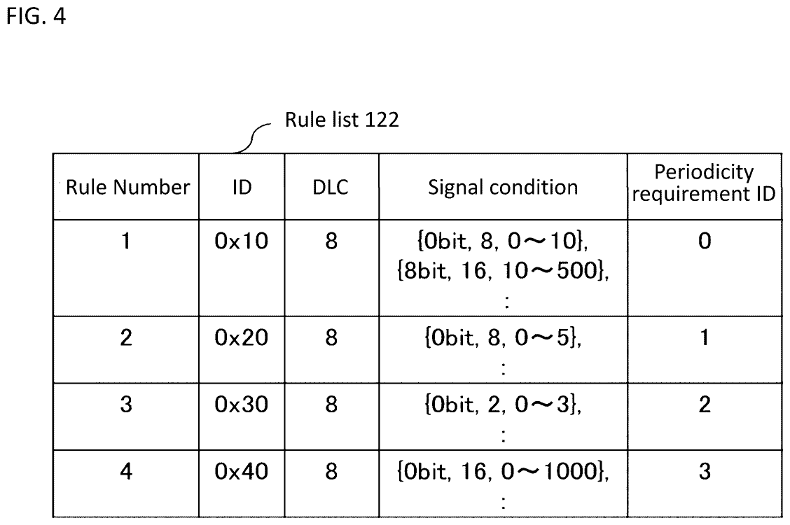

FIG. 4 shows an example of an internal configuration and possible values for the rule list 122 constituting the communication permission list 121. The communication permission list 121 is a list that describes information about a normal CAN message flowing in the vehicle system 10.

The items contained in the rule list 122 in the communication permission list 121 include a rule number, ID, DLC, a signal condition, and the periodicity requirement ID. The rule number is a sequential number assigned to uniquely identify each rule within the rule list 122. ID and DLC correspond to the ID and the DLC in the CAN communication message shown in FIG. 3. The signal condition defines the first bit of each signal, a length, the minimum value, and the maximum value in the CAN communication message shown in FIG. 3. The periodicity requirement ID is a number for associating the periodic message to the periodicity requirement list that defines the periodicity requirement.

The example in FIG. 4 describes information about four periodic messages having IDs of 0x10, 0x20, 0x30, and 0x40. Assume that the periodic message with ID=0x10 is a message with a period of 10 ms and its periodic error is significantly affected by the bandwidth load. Specifically, it is assumed that the message with ID=0x10 produces the periodic error of only less than ±1 ms for the 10 ms period when the bandwidth load on the cable 12 is low (for example, less than 40%), but produces the periodic error of less than ±2 ms for the 10 ms period when the bandwidth load on the cable 12 is medium (for example, from 40% to less than 70%), and produces the periodic error of less than ±3 ms for the 10 ms period when the bandwidth load on the cable 12 is high (for example, 70% or more).

Assume that the periodic message with ID=0x20 is a message whose period is 100 ms and whose periodic error is significantly affected by the transmission count. Specifically, it is assumed that in every series of four packets repeatedly transmitted as the periodic message with ID=0x20, the first three packets produce only less than ±2 ms of the periodic error for the 100 ms period, but the fourth packet always produces about 20 ms of delay.

Assume that the periodic message with ID=0x30 is a message whose period is 200 ms and whose periodic error is significantly affected by the time interval. Specifically, it is assumed that the periodic message with ID=0x30 has a repeated time interval in which it produces the periodic error of only less than ±5 ms against the 200 ms period for the first approximately 39 seconds, but produces the periodic error of ±15 ms or more for the following one second.

As for the periodic message with ID=0x40, it is assumed that it has a period of 500 ms, and the transition of its periodic error is not specifically related to the bandwidth load or the constant timing. For simplicity, only four rules for the CAN messages are shown in the rule list 122 in this example. However, it is desirable to list without omission all of the information of the normal CAN messages that may flow in the vehicle system 10, including messages that are not periodic.

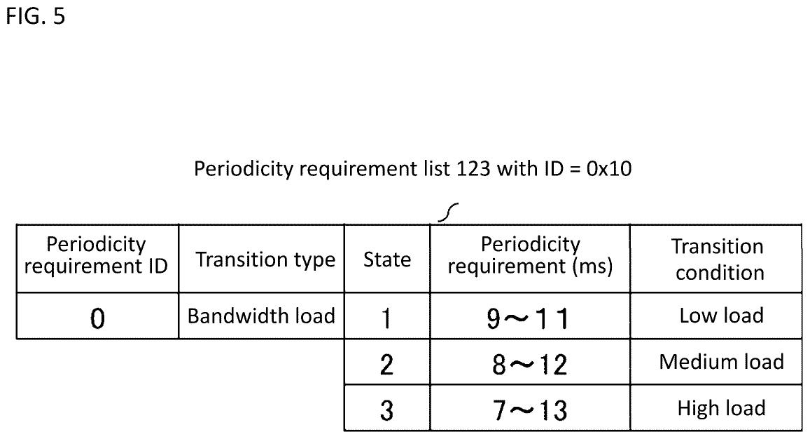

FIG. 5 shows an example of an internal configuration and possible values for a periodicity requirement list 123 with ID=0x10. The periodicity requirement list 123 includes, as its configuration items, the periodicity requirement ID, the transition type, the state, the periodicity requirement, and the transition condition. The periodicity requirement ID is a number for associating the rule list 122 to the periodicity requirement lists 123 to 126, and is the same number as the periodicity requirement ID given in the rule number 1 of the rule list 122, where the rules for ID=0x10 are described in the rule number 1. The transition type is marked as “Bandwidth load”, “Counter”, “Time”, or “None”. Here, “Counter” corresponds to the transmission count and “Time” corresponds to the time interval.

In Embodiment 1, the communication message with ID=0x10 is affected by the bandwidth load, therefore “Bandwidth load” is entered. This item may be marked in the form of a predetermined type-number or the like instead of a string. In the state and the transition condition, the conditions under which a difference appears in the periodic errors of the communication messages with ID=0x10 are defined. In Embodiment 1, the three stages of bandwidth load, namely low, medium, and high, cause the periodic error to change to less than ±1 ms, less than ±2 ms, and less than ±3 ms, respectively, so that these three stages are defined as the state. In the periodicity requirement, the periodicity requirement that is considered as normal in each state is described as a possible value range of time taken since the message is received last.

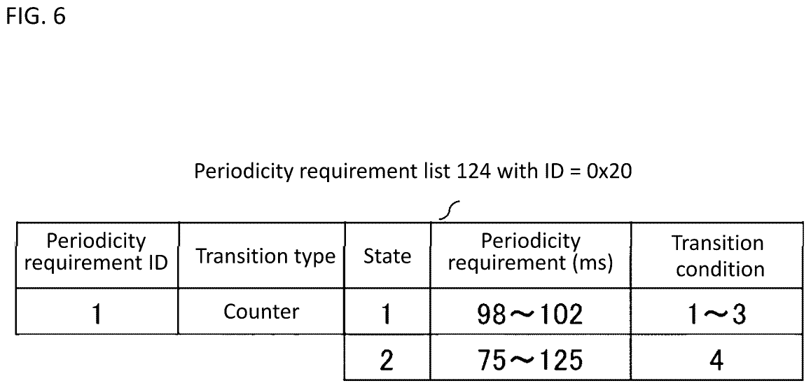

FIG. 6 shows an example of an internal configuration and possible values for a periodicity requirement list 124 with ID=0x20. The internal configuration of the periodicity requirement list 124 is identical to that of the periodicity requirement list 123. In the periodicity requirement list 124, the periodicity requirement ID is marked as one and the transition type is marked as “Counter”. As the state, two states of “the first three packets” and “the following one packet” are defined.

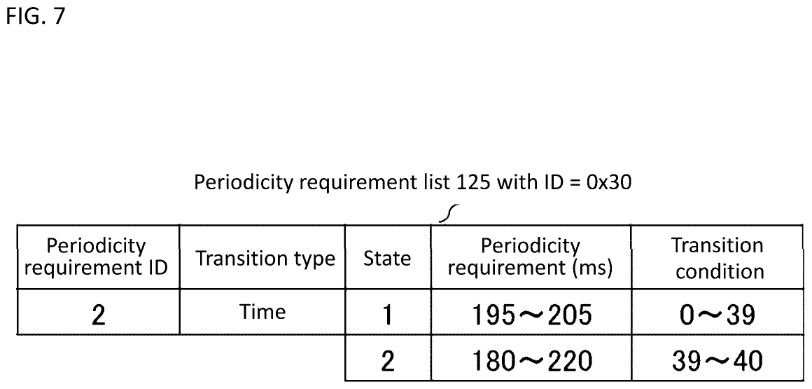

FIG. 7 shows an example of an internal configuration and possible values for a periodicity requirement list 125 with ID=0x30. The internal configuration of the periodicity requirement list 125 is identical to that of the periodicity requirement list 123. In the periodicity requirement list 125, the periodicity requirement ID is marked as two and the transition type is marked as “Time”. As the state, two states of “the first 39 seconds” and “the following one second” are defined.

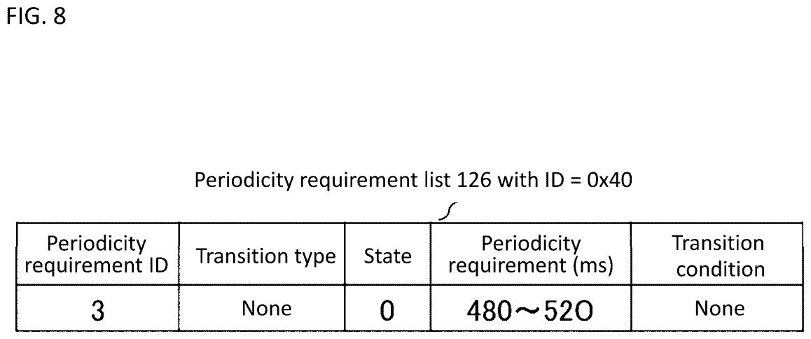

FIG. 8 shows an example of an internal configuration and possible values for a periodicity requirement list 126 with ID=0x40. The internal configuration of the periodicity requirement list 126 is identical to that of the periodicity requirement list 123. In the periodicity requirement list 126, the periodicity requirement ID is marked as three and the transition type is marked as “None”. Since there is no definition for the state, 0 is marked for the state and “None” is marked for the transition condition. The periodicity requirement should include an appropriate margin for the period of 500 ms, considering the periodic error that may occur in the real vehicle environment.

In Embodiment 1, a margin of ±20 ms is provided.

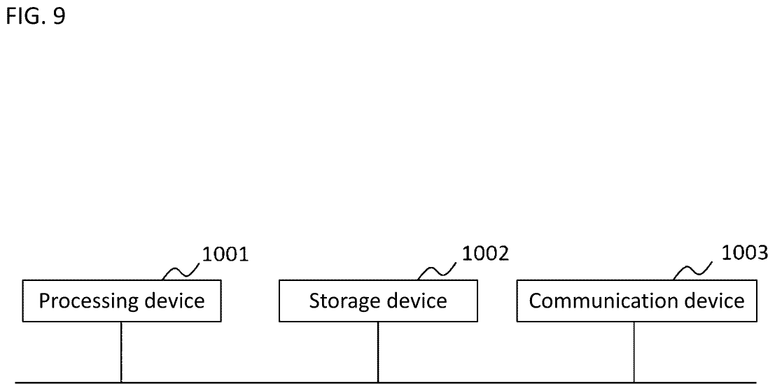

Next, a hardware configuration of the malicious communication detection device 100 will be described. FIG. 9 is a hardware configuration diagram showing a hardware configuration of the malicious communication detection device 100. The communication acquisition unit 111, the communication assessment unit 112, and the alerting unit 113 provided in the malicious communication detection device 100 are realized by a program executed by a processing device 1001, the program being stored in a storage device 1002.

The processing device 1001 is a processor such as a central processing unit (CPU), an arithmetic unit, a microprocessor, a microcomputer, and a digital signal processor (DSP). The functions of the malicious communication detection device 100 may be realized by a plurality of processors. The functions of the malicious communication detection device 100 may be realized by a field programmable gate array (FPGA) or an ASIC.

The storing unit 120 is realized by the storage device 1002, which may be, for example: a non-volatile or volatile semiconductor memory, such as a random access memory (RAM), a read only memory (ROM), a flash memory, an erasable programmable ROM (EPROM), and an electrically erasable programmable ROM (EEPROM); a magnetic disk, such as a hard disk and a flexible disk; or an optical disk, such as a MiniDisc, a compact disc (CD), and a digital versatile disc (DVD).

A communication device 3 is a device for communication equipped with a receiver and a transmitter. Specifically, the communication device 3 is a communication chip or a network interface card (NIC).

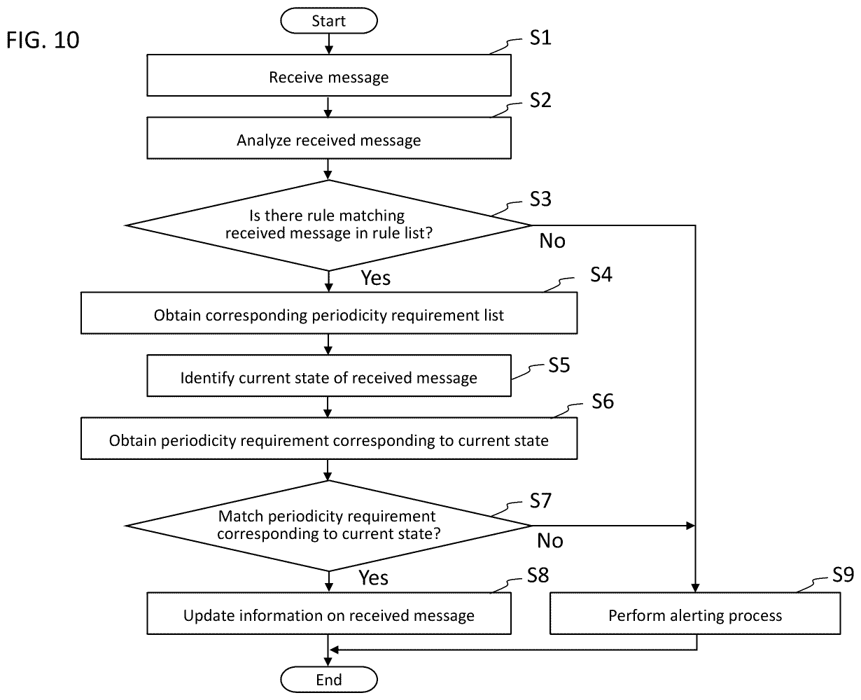

FIG. 10 is a flowchart showing an operation of the malicious communication detection device 100.

In Step S1, the communication acquisition unit 111 acquires the communication messages received by the reception unit 141 together with the reception time information in the reception unit 141 and transmits them to the communication assessment unit 112.

In Step S2, the communication assessment unit 112 analyzes the content of the received communication message to obtain the ID, the DLC, and the values of the data field contained in the message.

In Step S3, the communication assessment unit 112 determines whether there is information matching the communication message in the rule list 122. In the determination, a rule whose ID and DLC conditions match the values obtained in Step S2 is searched for among the rules for detection described in the rule list 122. If there is a rule that matches, values are read from the data field in accordance with the first bit and length information for all signals described in the signal condition of the rule and checked whether they are within the ranges of possible values.

If it is determined in Step S3 that there is no information matching the rules provided in the rule list 122, the process proceeds to Step S9. The alerting unit 113 then performs a predetermined alerting process. A variety of alerting processes may be performed via the transmission unit 142, such as transmitting log information indicating an occurrence of a malicious communication to a log storage device (not shown) in the vehicle system 10, or notifying an operator of the vehicle system 10 by displaying a warning on an operating panel (not shown). After the above processing steps are completed, this flowchart is terminated.

If it is determined in Step S3 that there is information matching a rule provided in the rule list 122, then in Step S4, the communication assessment unit 112 refers to the periodicity requirement ID of the rule list 122 to obtain a corresponding periodicity requirement list (one of 123 to 126).

In Step S5, the communication assessment unit 112 refers to the transition type of the obtained periodicity requirement list to identify the current state with respect to the message.

For example, if the message is a message with ID=0x10, the transition type of the periodicity requirement list 123 is “Bandwidth load”. Therefore, the state of the bandwidth load on the cable 12 is obtained from the reception unit 141 to determine which of low load (=1), medium load (=2), and high load (=3) corresponds to the current state.

If the message is a message with ID=0x20, the transition type of the periodicity requirement list 124 is “Counter”. Therefore, an internally managed value of a reception counter of the message with ID=0x20 is referenced. If the value is a multiple of 4, the current state is determined to be State 2, otherwise it is determined to be State 1.

If the message is a message with ID=0x30, the transition type of the periodicity requirement list 125 is “Time”. Therefore, an internally managed timer value from an initial reception of the message with ID=0x30 is referenced. If the timer value falls within the last one second of a 40 second interval, the current state is determined to be State 2, otherwise it is determined to be State 1.

If the message is a message with ID=0x40, the transition type of the periodicity requirement list 126 is “None”. Therefore, no further processing is performed, and the process proceeds to Step S6.

In Step S6, the communication assessment unit 112 obtains the periodicity requirement corresponding to the identified state.

In Step S7, the communication assessment unit 112 compares the reception time information obtained in Step S1 with the previous reception time information on the message held internally beforehand, and checks whether the reception interval is within the range of the periodicity requirement obtained in Step S6.

If it is determined in Step S7 that the reception interval is outside the range of the periodicity requirement, the process proceeds to Step S9, the alerting unit 113 performs a predetermined alerting process, and this flowchart is terminated.

If it is determined in Step S7 that the reception interval is within the range of the periodicity requirement, the communication assessment unit 112 determines that the message is a normal message, and updates the information on the message in Step S8. Specifically, the communication assessment unit 112 overwrites the previous reception time information on the message held internally with the reception time information received in Step S1. If the message is a message whose transition type is “Counter”, the communication assessment unit 112 increments the internally maintained value of the reception counter of the message.

After performing the above processing steps, the malicious communication detection device 100 terminates operation.

As described above, the malicious communication detection device 100 checks the communication message on the basis of the periodicity requirement for each time-varying state, thereby being able to determine more accurately whether the communication message is a normal message or not. It is also possible to detect and alert when a malicious message is transmitted from an unauthorized in-vehicle device, etc. attached to the inside of a vehicle to deceive control of driving or other operations of the vehicle. For the periodic message, the characteristics affecting the periodic error that may occur for each message are defined as the state, and the periodicity requirement is dynamically switched to the one corresponding to the current state, so that it is possible to achieve fine-tuned malicious communication detection that corresponds to the changes in the periodic error.

### (Communication Permission List Generation Phase)

Next, the process of generating the communication permission list 121 will be described.

The manual preparation of the communication permission list 121, as described above, demands a high workload for humans and leaves room for omissions and entry errors. Therefore, a communication permission list generation tool is required to automatically generate the communication permission list 121 shown in FIG. 2.

The following section describes a communication permission list generation device 200 that automatically generates the communication permission list 121. The operation of the communication permission list generation device 200 corresponds to a communication permission list generation method, and the program that enables the communication permission list generation method to be executed by a computer corresponds to a communication permission list generation program.

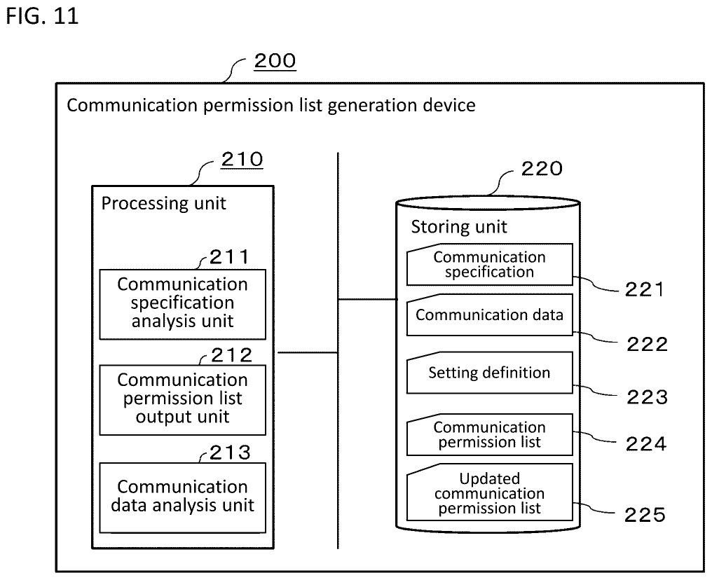

FIG. 11 is a configuration diagram of a configuration of the communication permission list generation device 200.

The communication permission list generation device 200 includes a processing unit 210 and a storing unit 220.

The storing unit 220 stores various information including a communication specification 221, communication data 222, a setting definition 223, a communication permission list 224, and an updated communication permission list 225.

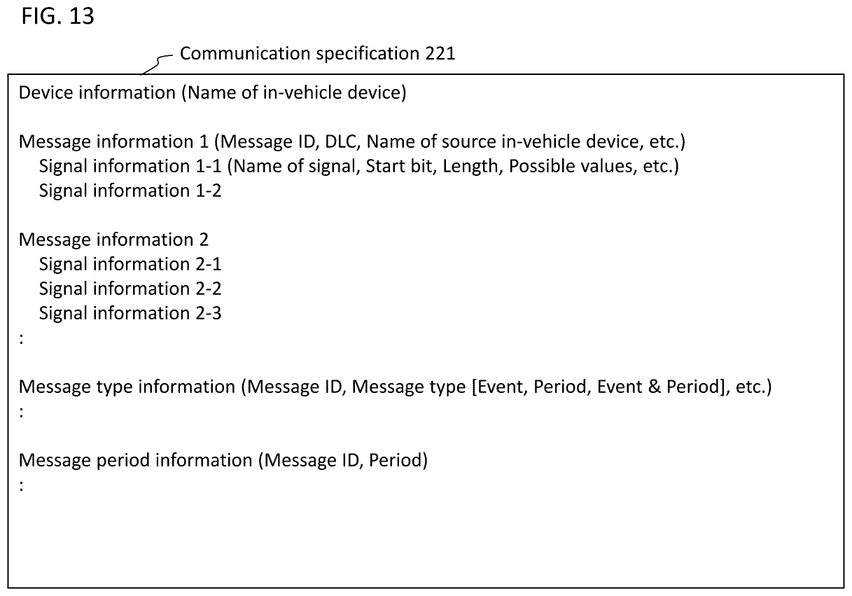

The communication specification 221 is a file that defines a communication specification of the CAN messages flowing in the vehicle system 10 shown in FIG. 1. Details of the communication specification 221 will be described later in FIG. 13. The communication data 222 is a file obtained by capturing and storing, using a packet capture tool, etc., the CAN messages actually flowing in the vehicle system 10 shown in FIG. 1.

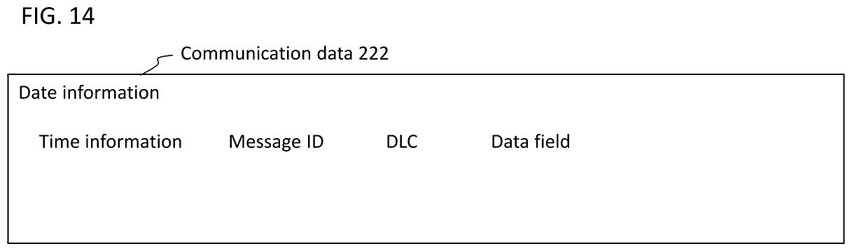

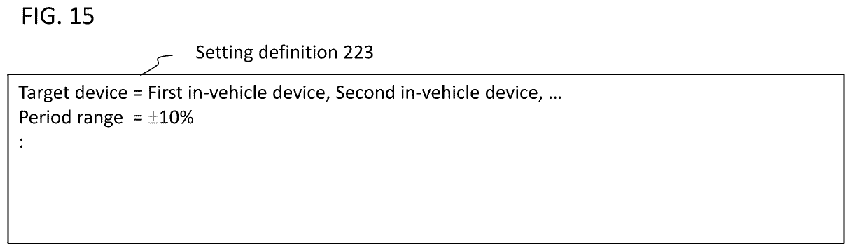

Details of the communication data 222 will be described later in FIG. 14. The setting definition 223 is a file that describes setting information when the processing unit 210 performs the operation. Details of the setting definition 223 will be described later in FIG. 15.

The communication permission list 224 is a file outputted by a communication permission list output unit 212, and the updated communication permission list 225 is a file outputted by a communication data analysis unit 213, and the formats of these files are the same as that of the communication permission list 121 shown in FIG. 2.

In addition, the storing unit 220 stores data, not shown, which is used, generated, inputted, outputted, transmitted, or received by the communication permission list generation device 200.

The processing unit 210 includes a communication specification analysis unit 211, the communication permission list output unit 212, and the communication data analysis unit 213.

The communication specification analysis unit 211 analyzes a communication specification that defines a specification of a normal communication message.

The communication permission list output unit 212 generates a communication permission list that is used to detect a malicious communication message on the basis of the analysis results by the communication specification analysis unit.

The communication data analysis unit 213 identifies conditions under which variation occurs in the periodic errors of the communication messages included in the communication data 222 on the basis of the actual communication data 222, determines the normal period range for each identified condition, and updates the communication permission list. The term “conditions” here means the transition type and the transition conditions.

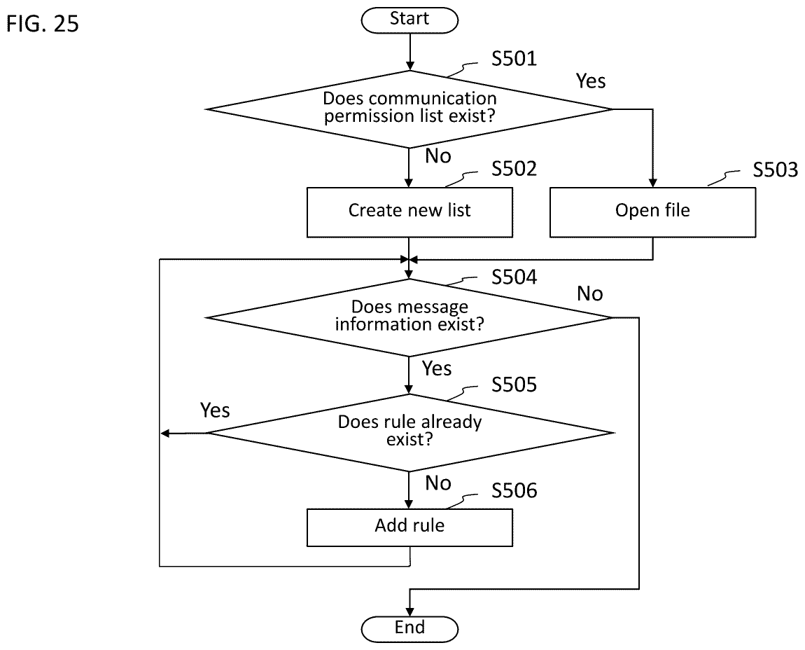

In Embodiment 1, on the basis of the communication data 222, the communication data analysis unit 213 calculates the bandwidth load for each unit of time, classifies the calculated bandwidth loads into multiple stages, and compares the periodic errors between the multiple stages to identify the conditions. More specifically, if the periodic error difference is larger than a predetermined threshold between the multiple stages, the communication data analysis unit 213 determines that the transition type is “Bandwidth load” among the conditions, and identifies the transition conditions on the basis of the classified multiple stages. More details of the process will be described in FIG. 25.

In Embodiment 1, the communication data analysis unit 213 also checks whether the periodic errors of the communication messages exceed a predetermined threshold at a constant counter interval to identify the above-described factor. More specifically, if the periodic errors of the communication messages exceed a predetermined threshold at a constant counter interval, the communication data analysis unit 213 determines that the transition type is “Transmission count” among the conditions and identifies the transition conditions on the basis of the constant counter interval mentioned above. More details of the process will be described in FIG. 25.

In Embodiment 1, the communication data analysis unit 213 also checks whether the periodic errors of the communication messages exceed a predetermined threshold at a constant time interval to determine the conditions. More specifically, if the periodic errors of the communication messages exceed a predetermined threshold at a constant time interval, the communication data analysis unit 213 determines that the transition type is “Time interval” among the conditions and identifies the transition conditions on the basis of the constant time interval mentioned above. More details of the process will be described in FIG. 25.

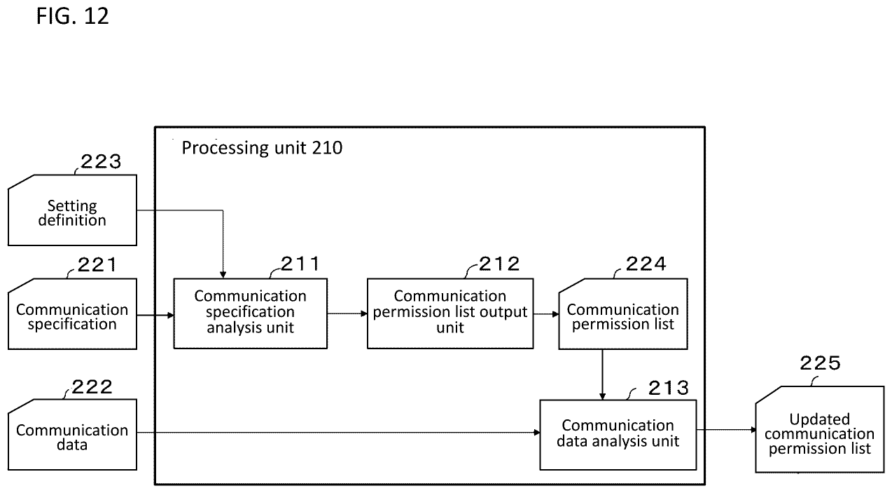

FIG. 12 is a flow diagram illustrating the internal operation and input/output information of the processing unit 210 shown in FIG. 11.

The processing unit 210 receives the communication specification 221, the setting definition 223, and the communication data 222 and outputs the updated communication permission list 225. The communication permission list 224 is generated inside the processing unit 210.

The communication specification analysis unit 211 analyzes the content of the communication specification 221 on the basis of the setting definition 223. The analysis results are outputted to the communication permission list output unit 212.

The communication permission list output unit 212 generates the communication permission list 224 in accordance with the content of the inputted analysis results.

The communication data analysis unit 213 analyzes the content of the communication data 222, updates the content of the communication permission list 224 in accordance with the analysis results, and outputs the updated results as the updated communication permission list 225.

Here, the processing unit 210 may output the communication permission list 224 externally, instead of just retaining it as internal information. In this case, the processing unit 210 is to output both the communication permission list 224 and the updated communication permission list 225.

Further, the processing unit 210 may be separated into one functional unit consisting of the communication specification analysis unit 211 and the communication permission list output unit 212, and another functional unit consisting of the communication data analysis unit 213, each of which may be operated as a separate device. In this case, the functional unit consisting of the communication specification analysis unit 211 and the communication permission list output unit 212 receives the communication specification 221 and the setting definition 223, and outputs the communication permission list 224. The functional unit consisting of the communication data analysis unit 213 receives the communication specification 221, the communication data 222, and the communication permission list 224 and outputs the updated communication permission list 225.

FIG. 13 shows an example of a format of the communication specification 221 shown in FIGS. 11 and 12. The communication specification 221 is a CAN database file in which the specification of the CAN messages flowing in the vehicle system 10 is defined. The communication specification 221 is design information created and used in the development stages of each in-vehicle device, such as the vehicle system 10, the GW (gateway) 11, the first in-vehicle device 1, the second in-vehicle device 2, . . . and the nth in-vehicle device n. The communication specification 221 may consist of multiple files instead of one file.

The communication specification 221 includes device information, message information, information about signals constituting a message, message type information, message period information, etc. The device information includes names of the in-vehicle devices involved in transmitting and receiving messages defined in the communication specification 221. The message information is information about the message ID, DLC, and the name of the source in-vehicle device for each of the messages. Each piece of message information includes the signal information that constitutes the data field portion of the message. The signal information is information about the signal name, start bit, length, possible values, etc. The message type information is information about the type of each message defined in the message information. The message types include, for example, a type of message that is transmitted when triggered by an event and a type of message that is transmitted periodically. The message period information is information about the transmission period of the message defined as periodic in the message type information.

FIG. 14 shows an example of a format of the communication data 222 shown in FIGS. 11 and 12. The communication data 222 is a file obtained by capturing and storing, using the packet capture tool, etc., the messages flowing in the vehicle system 10. The communication data 222 is information for development and evaluation obtained from a real vehicle or in a simulator environment in the development stages of each in-vehicle device, such as the vehicle system 10, the GW (gateway) 11, the first in-vehicle device 1, the second in-vehicle device 2, . . . and the nth in-vehicle device n, etc. The communication data 222 may consist of multiple files instead of one file.

The communication data 222 includes date information and information about the captured communication message. The information about the communication message includes a capture time, the message ID, DLC, and the data field.

FIG. 15 shows an example of a format of the setting definition 223 shown in FIGS. 11 and 12. The setting definition 223 is a text file that defines the setting information regarding the operation of the processing unit 210. The setting definition 223 includes information regarding target devices, period ranges, etc. The target devices are defined as the source in-vehicle devices of the message to be analyzed by the communication specification analysis unit 211. The communication permission list 224 outputted by the communication permission list output unit 212 will only define rules with respect to the messages transmitted by the in-vehicle devices defined as the target devices. The definition of the target devices may be omitted. In this case, all the messages defined in the communication specification 221 become the analysis targets of the communication specification analysis unit 211. The period range specifies as a ratio how much margin should be contained in the definition of the periodicity requirement in the communication permission list 224 with respect to the periodic information defined in the communication specification 221. The ratio defined in the period range applies to all the periodic messages defined in the communication specification 221.

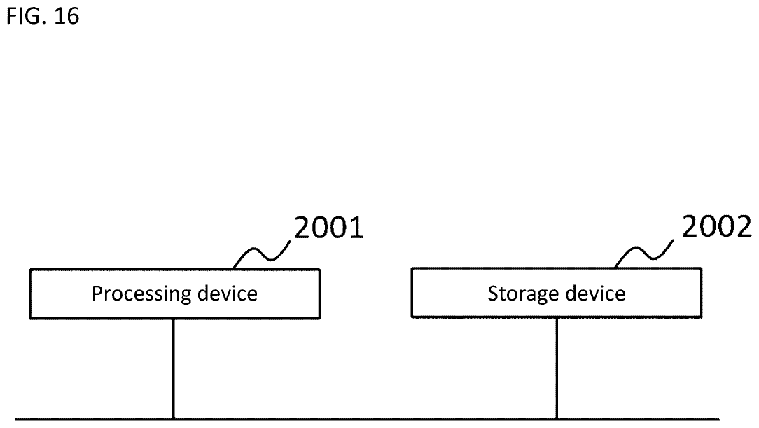

Next, a hardware configuration of the communication permission list generation device 200 will be described. FIG. 16 is a hardware configuration diagram showing a hardware configuration of the communication permission list generation device 200. The communication specification analysis unit 211, the communication permission list output unit 212, and the communication data analysis unit 213 included in the communication permission list generation device 200 are realized by a program stored in a storage device 2002 and executed by a processing device 2001.

The processing device 2001 is a processor such as a central processing unit (CPU), an arithmetic unit, a microprocessor, a microcomputer, and a digital signal processor (DSP). The functions of the communication permission list generation device 200 may be realized by a plurality of processors. The functions of the communication permission list generation device 200 may be realized by a field programmable gate array (FPGA) or an ASIC.

The storing unit 220 is realized by the storage device 2002, which may be, for example: a non-volatile or volatile semiconductor memory, such as a random access memory (RAM), a read only memory (ROM), a flash memory, an erasable programmable ROM (EPROM), and an electrically erasable programmable ROM (EEPROM); a magnetic disk, such as a hard disk and a flexible disk; or an optical disk, such as a MiniDisc, a compact disc (CD), and a digital versatile disc (DVD).

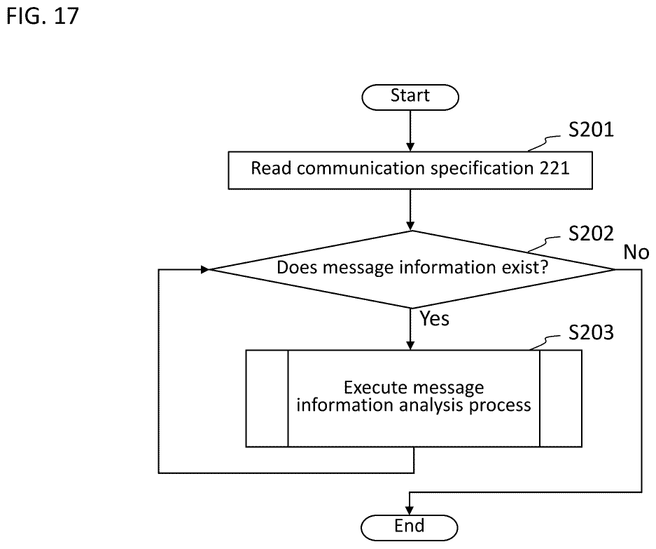

FIG. 17 is a flowchart of a communication specification analysis process performed by the communication specification analysis unit 211 shown in FIGS. 11 and 12.

The communication specification analysis unit 211 reads the content of the communication specification 221 accepted as input in Step S201. Specifically, the message information is searched from the beginning in the format of the communication specification 221 shown in FIG. 13.

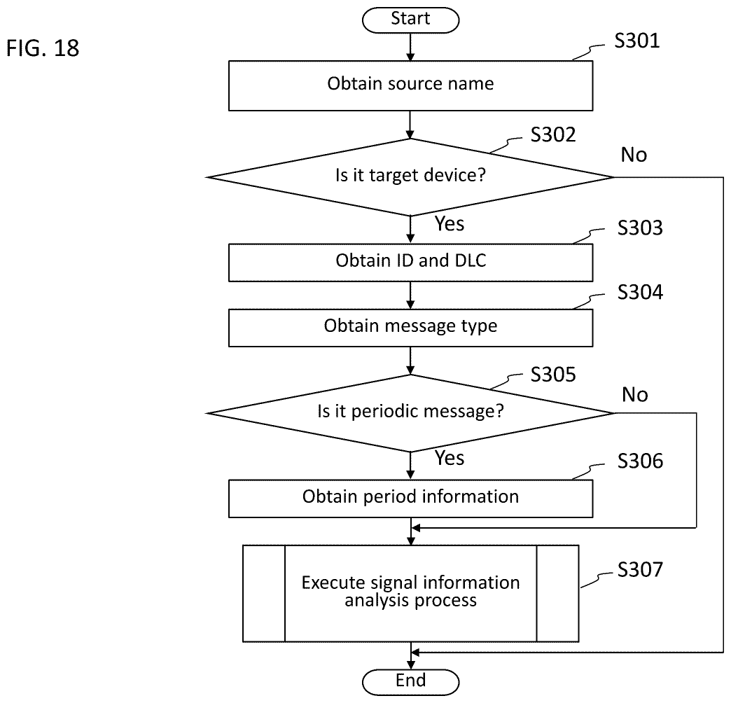

Then, in Step S202, the communication specification analysis unit 211 determines whether the message information exists. If a message exists, a subroutine of a message information analysis process is executed in Step S203. The message information analysis subroutine will be described later in FIG. 18. After executing the message information analysis subroutine, the process returns to Step S202.

Thereafter, Steps S202 to S203 are repeated until all pieces of the message information in the communication specification 221 are analyzed.

This flowchart is terminated if the communication specification analysis unit 211 determines in Step S202 that the next message information does not exist.

FIG. 18 is a flowchart showing the message information analysis subroutine performed by the communication specification analysis unit 211. The process in FIG. 18 corresponds to Step S203 in FIG. 17.

In Step S301, the communication specification analysis unit 211 obtains the name of the source in-vehicle device of the message to be analyzed from the communication specification 221.

Next, in Step S302, it is determined whether the name of the source in-vehicle device obtained in Step S301 is defined as a target device in the setting definition 223 shown in FIG. 15.

If not defined, this flowchart is terminated immediately.

If defined, in Step S303, the communication specification analysis unit 211 obtains the ID and DLC of the message to be analyzed from the communication specification 221.

In Step S304, the communication specification analysis unit 211 obtains the message type of the message to be analyzed from the communication specification 221.

Then, in Step S305, the communication specification analysis unit 211 determines whether the message to be analyzed is a periodic message.

If it is a periodic message, in Step S306, the communication specification analysis unit 211 obtains the period information of the message to be analyzed from the communication specification 221 and calculates the lower and upper limits using the ratio specified by the period range of the setting definition 223 shown in FIG. 15. For example, if the obtained period information is 10 ms and the margin is specified as 10% in the period range of the setting definition 223, the periodicity requirement of the periodic message ranges from 9 to 11 ms.

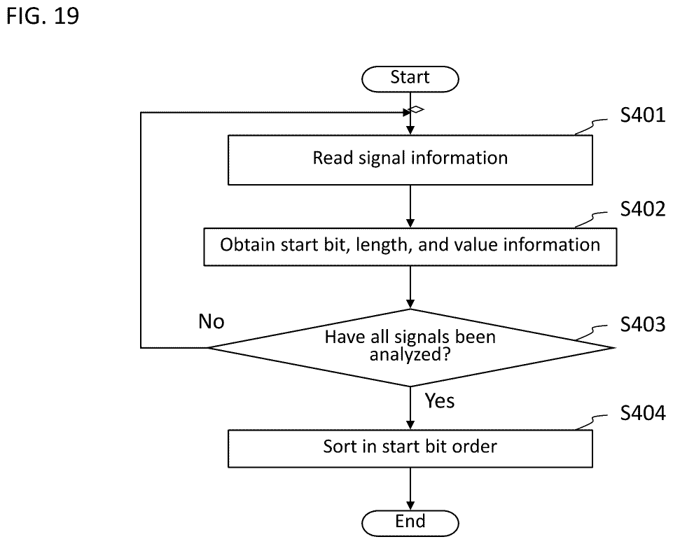

In Step S307, a subroutine of a signal information analysis process is executed. The signal information analysis subroutine will be described later in FIG. 19.

On the other hand, in Step S305, if the message is not a periodic message, the process immediately proceeds to Step S307 and executes the signal information analysis subroutine. After executing the above processing steps, this flowchart is terminated.

FIG. 19 is a flowchart showing the signal information analysis subroutine performed by the communication specification analysis unit 211. FIG. 19 corresponds to Step S307 in FIG. 18.

In Step S401, the communication specification analysis unit 211 reads the signal information of the message to be analyzed from the communication specification 221.

In Step S402, the communication specification analysis unit 211 obtains the information about the start bit, length, and possible values from the signal information.

In Step S403, the communication specification analysis unit 211 determines whether the analysis of all pieces of the signal information regarding the messages to be analyzed is completed.

If not completed, the process returns to Step S404. Thereafter, Steps S401 to S403 are repeated until no unanalyzed signal information remains.

When the analysis of all pieces of the signal information on the messages to be analyzed is completed in Step S403, in Step S404, the communication specification analysis unit 211 sorts the pieces of the signal information obtained in Step S402 in ascending order of the start bit.

After executing the above processing steps, this flowchart is terminated.

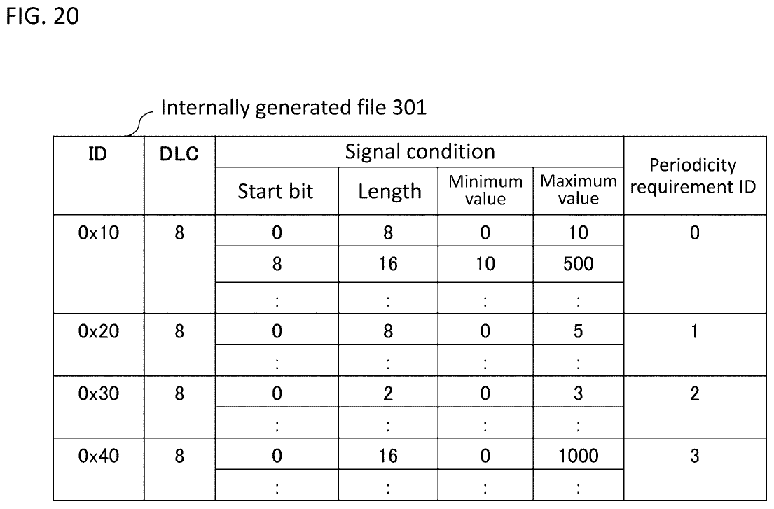

FIGS. 20 to 24 are examples of files generated as results of the communication specification analysis process performed by the communication specification analysis unit 211 shown in FIGS. 17 to 19.

Each file shown in FIGS. 20 to 24 is information to be inputted from the communication specification analysis unit 211 to the communication permission list output unit 212 within the processing unit 210.

An internally generated file 301, shown in FIG. 20, includes the ID, DLC, signal condition, and periodicity requirement ID. For the ID and DLC, the information obtained in S303 of FIG. 18 is stored. The signal condition includes a start bit, a length, a minimum value, and a maximum value, each of which stores the information obtained in S402 of FIG. 19. As a result of the sorting process in S404 of FIG. 19, the signal condition for each ID is recorded in the internally generated file 301 in ascending order of the value of the start bit. The periodicity requirement ID is a number for associating each periodic message to one of an internally generated file 302 to an internally generated file 305, which will be described later. The example in FIG. 20 shows information about the four periodic messages with IDs 0x10, 0x20, 0x30, and 0x40, which are the same as those shown in FIG. 4.

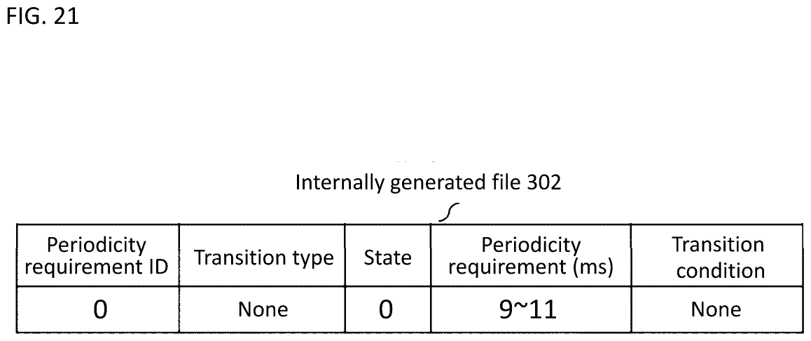

The internally generated file 302 shown in FIG. 21 is a file containing the periodicity requirement for the message with ID 0x10. The internally generated file 302 shown in FIG. 21 includes the periodicity requirement ID, transition type, state, periodicity requirement, and transition condition, as does the periodicity requirement list 123 with ID=0x10 shown in FIG. 5. For the periodicity requirement, the period range calculated in S306 of FIG. 18 is stored. Since the information regarding the transition type, state, and transition condition cannot be obtained from the communication specification 221, the transition type is stored as “None”, the state is stored as 0, and the transition condition is stored as “None”.

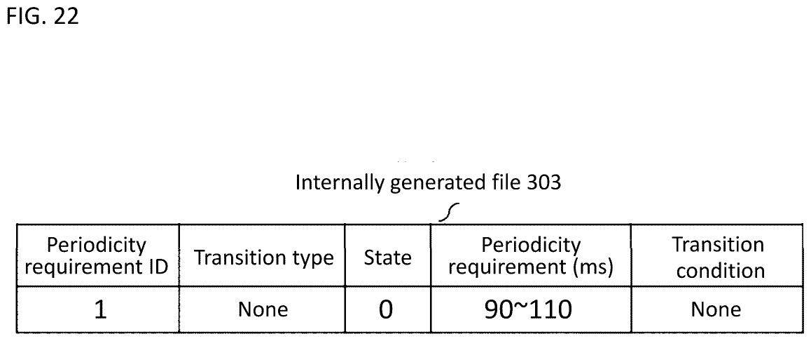

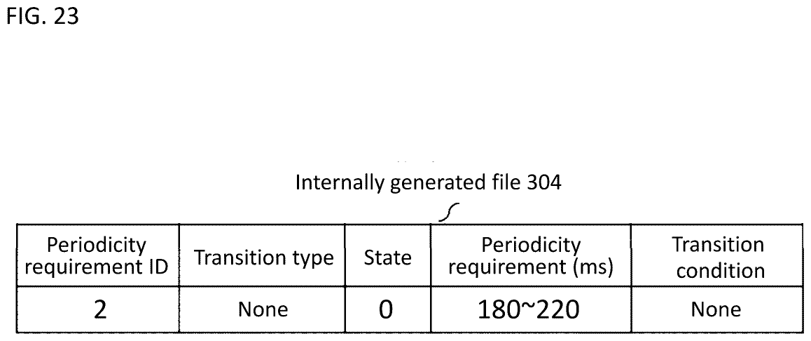

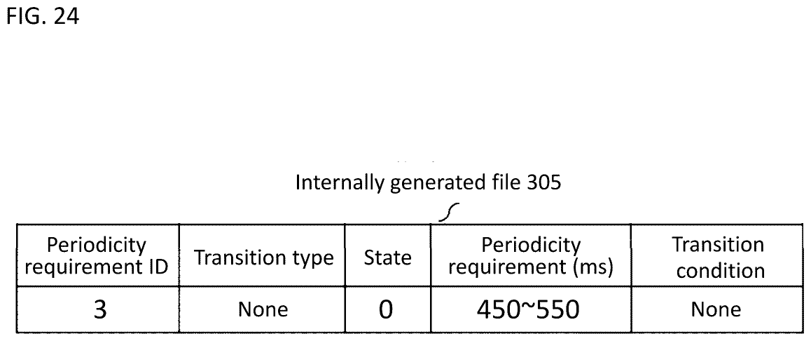

Similarly, the internally generated file 303 shown in FIG. 22 is a file containing the periodicity requirement for the message with ID 0x20. The internally generated file 304 shown in FIG. 23 is a file containing the periodicity requirement for the message with ID 0x30. The internally generated file 305 shown in FIG. 24 is a file containing the periodicity requirement for the message with ID 0x40. In each file, as in the internally generated file 302 shown in FIG. 21, the periodicity requirement contains the period range calculated in S306 of FIG. 18, the transition type is stored as “None”, the state is stored as 0, and the transition condition is stored as “None”.

FIG. 25 is a flowchart of a communication permission list output process performed by the communication permission list output unit 212 shown in FIGS. 11 and 12.

In Step S501, the communication permission list output unit 212 determines whether the communication permission list 224 already exists.

If it does not exist, in Step S502, the communication permission list output unit 212 creates a new communication permission list 224. The communication permission list 224 includes the rule list and the plurality of periodicity requirement lists, as does the communication permission list 121 shown in FIG. 2. After executing the processing step in Step S502, the process proceeds to Step S504.

On the other hand, if the communication permission list 224 already exists in Step S501, in Step S503, the communication permission list output unit 212 opens the file so that the existing the communication permission list 224 can be edited, and then proceeds to Step S504.

In Step S504, the communication permission list output unit 212 determines whether the message information exists in the internally generated file 301.

If it exists, in Step S505, the communication permission list output unit 212 determines whether the rule corresponding to the message information in the internally generated file 301 already exists in the communication permission list 224. Specifically, the communication permission list output unit 212 obtains the ID of the message to be analyzed from the internally generated file 301 to first determine whether a rule with the same ID exists in the rule list within the communication permission list 224. If it exists, the communication permission list output unit 212 determines whether the DLC, signal condition, and periodicity requirement ID of the internally generated file 301 match the DLC, signal condition, and periodicity requirement ID of the rule in the corresponding communication permission list 224. If they match, the communication permission list output unit 212 further identifies the file with the corresponding periodicity requirement ID from among the internally generated file 302 to the internally generated file 305, obtains the periodicity requirement from the identified file, and determines whether the obtained periodicity requirement matches the periodicity requirement of the corresponding periodicity requirement list in the communication permission list 224. If it matches, the communication permission list output unit 212 determines that the rule with the same ID exists in the communication permission list 224 and returns to Step S504.

If the rule with the same ID does not exist in the communication permission list 224 in Step S505, in Step S506, the communication permission list output unit 212 adds, to the communication permission list 224, the information of the ID, DLC, signal condition, and periodicity requirement ID of the internally generated file 301 and the information of the transition condition, state, periodicity requirement, transition condition of the file with the corresponding periodicity requirement ID from among the internally generated file 302 to the internally generated file 305, and returns to Step S504.

Thereafter, the processing steps from Step S504 to Step S506 are repeated until all pieces of the message information in the internally generated file 301 are read.

In Step S504, if there is no next message information left in the internally generated file 301, this flowchart is terminated.

The formats of the rule list and the periodicity requirement lists in the communication permission list 224 generated when the communication permission list output process shown in FIG. 25 is performed with the contents of the internally generated file 301 to the internally generated file 305 shown in FIGS. 20 to 24 provided as input are the same format as those in the rule list 122 and the periodicity requirement list 123 to the periodicity requirement list 126 shown in FIGS. 4 to 8.

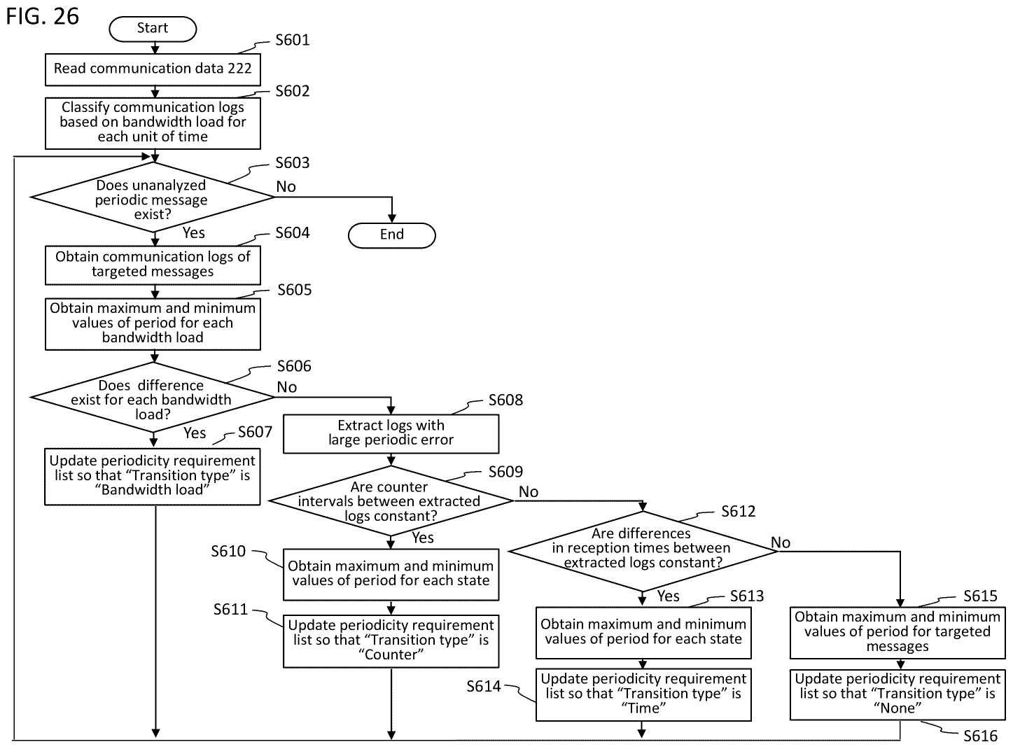

FIG. 26 is a flowchart of the communication data analysis process performed by the communication data analysis unit 213 shown in FIGS. 11 and 12.

The communication data analysis unit 213 reads the content of the communication data 222 accepted as input in Step S601.

In Step S602, the communication data analysis unit 213 calculates the bandwidth load for each unit of time from the content of the communication data 222 and classifies communication logs for each unit of time into three stages of low (less than 40%), medium (40% to less than 70%), and high (70% or more) in terms of bandwidth load.

In Step S603, the communication data analysis unit 213 refers to the rule list in the communication permission list 224 generated in the communication permission list output process shown in FIG. 25 and determines whether there is an unanalyzed periodic message in the communication logs in the communication data 222. When the analysis of all periodic messages is completed, this flowchart is terminated.

If there is an unanalyzed periodic message in the determination of Step S603, in Step S604, the communication data analysis unit 213 obtains all communication logs matching the ID of the unanalyzed periodic message from the communication data 222 and assigns each communication log a log number that is sequential from the beginning.

In Step S605, the communication data analysis unit 213 obtains the maximum value and the minimum value of the period of the periodic messages to be analyzed for each of the low, medium, and high periods in terms of bandwidth load from the result of the classification in Step S602 and the result obtained in Step S604.

In Step S606, the communication data analysis unit 213 compares the maximum values and the minimum values of the period between the bandwidth loads and determines whether the difference is larger than a predetermined threshold.

If they are, in Step S607, the communication data analysis unit 213 updates the content of the periodicity requirement list for the periodic messages in the communication permission list 224. In the update, “Transition type” in the periodicity requirement list is changed to “Bandwidth load”; the state and the transition condition are defined as three stages of low, medium, and high in terms of bandwidth load; and the periodicity requirement for each state is set as a value range based on the maximum value and the minimum value of the period obtained in Step S605. As a result of performing this processing step, the content of the periodicity requirement list for the periodic messages within the communication permission list 224 is updated, for example, from the content of the internally generated file 302 shown in FIG. 21 to the content of the periodicity requirement list 123 with ID=0x10 shown in FIG. 5.

If the comparison in Step S606 does not show a large difference in the periodic errors between the bandwidth loads, in Step S608, the communication data analysis unit 213 extracts the logs whose periodic errors exceed a predetermined threshold from all communication logs of the periodic messages obtained in Step S604.

In Step S609, the communication data analysis unit 213 checks the log number of the extracted log and determines whether a communication log with a large deviation occurs at a constant counter interval.

If the counter interval is constant, in Step S610, the communication data analysis unit 213 classifies all communication logs of the periodic messages obtained in Step S604 into two groups of communication logs with a larger periodic error and other communication logs, and obtains the maximum value and the minimum value of the period in each group.

In Step S611, the communication data analysis unit 213 updates the content of the periodicity requirement list for the periodic messages in the communication permission list 224. In the update, “Transition type” in the periodicity requirement list is changed to “Counter”, and “State” is defined as two states representing the respective states of the two groups as is. The transition condition is defined as the timing that causes the periodic error to increase and the rest of the timing. The periodicity requirement for each state is set to a value range based on the maximum value and the minimum value of the period obtained in S610. As a result of performing this processing step, the content of the periodicity requirement list for the periodic messages within the communication permission list 224 is updated, for example, from the content of the internally generated file 303 shown in FIG. 22 to the content of the periodicity requirement list 124 with ID=0x20 shown in FIG. 6.

On the other hand, if it is determined in Step S609 that the log numbers of communication logs with a large periodic error are not recorded at a constant counter interval, in Step S612, the communication data analysis unit 213 groups the communication logs with a large periodic error according to the closeness in reception times and determines whether the time interval between the groups is constant.

If the time interval is constant, in Step S613, the communication data analysis unit 213 classifies all communication logs of the periodic messages obtained in Step S604 into two groups of communication logs with a larger periodic error and other communication logs, and obtains the maximum value and the minimum value of the period in each group.

In Step S614, the communication data analysis unit 213 updates the content of the periodicity requirement list for the periodic messages in the communication permission list 224. In the update, “Transition type” in the periodicity requirement list is changed to “Time”, and “State” is defined as two states representing the respective states of the two groups as is. The transition condition is defined as the timing that causes the periodic error to increase and the rest of the timing. The periodicity requirement for each state is set to a value range based on the maximum value and the minimum value of the period obtained in S613. As a result of performing this processing step, the content of the periodicity requirement list for the periodic messages within the communication permission list 224 is updated, for example, from the content of the internally generated file 304 shown in FIG. 23 to the content of the periodicity requirement list 125 with ID=0x30 shown in FIG. 7.

On the other hand, if it is determined in Step S612 that the time interval is not constant, in Step S615, the communication data analysis unit 213 obtains the maximum value and the minimum value of the period in all communication logs of the periodic messages obtained in Step S604.

In Step S616, the communication data analysis unit 213 updates the content of the periodicity requirement list for the periodic messages in the communication permission list 224. The periodicity requirement is set to a value range based on the maximum value and the minimum value of the period obtained in S615. The transition type, state, and transition condition have already stored the information of “None”, 0, and “None”, respectively, in the processing step of S506 shown in FIG. 25. Therefore, they are not changed in this processing step. As a result of performing this processing step, the content of the periodicity requirement list for the periodic messages within the communication permission list 224 is updated, for example, from the content of the internally generated file 305 shown in FIG. 24 to the content of the periodicity requirement list 126 with ID=0x40 shown in FIG. 8.

After performing the above processing steps, the communication data analysis unit 213 returns to Step S603 and then repeats the processing steps from Step S603 to Step S616 until the analysis of all periodic messages is completed, and terminates the operation when the analysis for all periodic messages is completed.

As described above, the communication permission list generation device 200 makes it possible to automatically generate the periodicity requirements which take into account the characteristics of each periodic message, from the communication specifications and the communication data without relying on manual human labor. Then, when used in combination with the malicious communication detection device 100, the malicious communication detection capable of suppressing the occurrence of both false positives and false negatives can be realized.

(Other forms)

Other forms of the malicious communication detection device and the communication permission list generation device according to the present disclosure will be described below.

Embodiment 1 is described to cover CAN messages in a vehicle system as an example, but the applicability of the malicious communication detection device and the communication permission list generation device according to the present disclosure is not necessarily limited to the above. For example, the malicious communication detection device according to the present disclosure may be mounted on a device in an IoT system built in a factory, building, or home and detect a malicious TCP/IP communication over a wired or wireless LAN. In this case, the items that constitute the rule list 122 shown in FIG. 4 are: not the ID, but source and destination addresses (IP addresses, port numbers, protocol numbers, etc.); not the DLC, but a data length of a payload portion of a TCP/IP message; and not the signal condition, but a payload condition. Also, the communication specification 221 shown in FIG. 13 corresponds to a specification that defines the TCP/IP communication flowing in the IoT system, and the communication data 222 shown in FIG. 14 corresponds to a file obtained by capturing the TCP/IP communication flowing in the IoT system.

Although in Embodiment 1, there were the four types of “Bandwidth load”, “Counter”, “Time”, and “None” as the transition type that can be taken by the periodicity requirement lists 123 to 126 shown in FIGS. 5 to 8, other types may be prepared. Instead of defining the transition types in advance in a fixed manner, the communication data analysis unit 213 shown in FIG. 11 may dynamically define the transition types on the basis of the characteristic of each periodic message extracted from the communication data 222.

The embodiment described above is an example of a preferred form and is not intended to limit the technical scope of the present disclosure. The embodiment may be implemented in part or in combination with others. The procedures described in the flowcharts and others may be modified as needed.

### INDUSTRIAL AVAILABILITY

The malicious communication detection device and the communication permission list generation device according to the present disclosure are suitable for use in malicious communication detection of the communication messages flowing in a vehicle system and an IoT system.

### DESCRIPTION OF THE SYMBOLS

1 . . . first in-vehicle device,
2 . . . second in-vehicle device,
10 . . . vehicle system,
11 . . . GW,
12 . . . cable,
100 . . . malicious communication detection device,
110 . . . processing unit,
111 . . . communication acquisition unit,
112 . . . communication assessment unit,
113 . . . alerting unit,
120 . . . storing unit,
121 . . . communication permission list,
122 . . . rule list,
123,124,125,126 . . . periodicity requirement list,
130 . . . GW functional unit,
140 . . . communication unit,
141 . . . reception unit,
142 . . . transmission unit,
200 . . . communication permission list generation device,
210 . . . processing unit,
211 . . . communication specification analysis unit,
212 . . . communication permission list output unit,
213 . . . communication data analysis unit,
220 . . . storing unit,
221 . . . communication specification,
222 . . . communication data,
223 . . . setting definition,
224 . . . communication permission list,
225 . . . updated communication permission list,
301, 302, 303, 304, 305 . . . internally generated file,
1001 . . . processing device,
1002 . . . storage device,
1003 . . . communication device,
2001 . . . processing device,
2002 . . . storage device.

1. A malicious communication detection device comprising:
a processor to execute a program; and
a memory to store the program which, when executed by the processor, performs processes of acquiring a communication message and determining whether the communication message is a normal message on the basis of a periodicity requirement set for each of time-varying states of the communication message,
wherein the periodicity requirement of the communication message is identified on the basis of a state of the communication message classified according to a transition type which is a factor affecting a periodic error of the communication message and a plurality of transition conditions which is set for each transition type to determine whether the communication message is a normal message.

2. A malicious communication detection device comprising:
a processor to execute a program; and
a memory to store the program which, when executed by the processor, performs processes of acquiring a communication message and determining whether the communication message is a normal message on the basis of a periodicity requirement set for each of time-varying states of the communication message,
wherein the state of the communication message is identified on the basis of at least one of a bandwidth load, a transmission count, and a time interval to determine whether the communication message is a normal message according to the periodicity requirement set for the identified state of the communication message.

3. A communication permission list generation device comprising:
a processor to execute a program; and
a memory to store the program which, when executed by the processor, performs processes of analyzing a communication specification in which a specification of a normal communication message is defined, generating a communication permission list which is used to detect a malicious communication message on the basis of the result of the communication specification analysis, identifying, on the basis of actual communication data, a condition under which a variation occurs in a periodic error of a communication message contained in the communication data, determining a normal period range for each condition, and updating the communication permission list.

4. The communication permission list generation device according to claim 3, wherein a bandwidth load per unit time is calculated on the basis of the communication data, the calculated bandwidth loads are classified into multiple stages, and the periodic errors are compared between the multiple stages, thereby identifying the condition.

5. The communication permission list generation device according to claim 3, wherein the condition is identified by determining whether the periodic errors of the communication messages exceed a predetermined threshold at a constant counter interval.

6. The communication permission list generation device according to claim 3, wherein the condition is identified by determining whether the periodic errors of the communication messages exceed a predetermined threshold at a constant time interval.

7. A communication system comprising:
a malicious communication detection device provided with a processor to execute a program and a memory to store the program which, when executed by the processor, performs processes of acquiring a communication message and determining whether the communication message is a normal message on the basis of a periodicity requirement set for each time-varying state of the communication message; and
the communication permission list generation device according to claim 3.

8. A malicious communication detection method comprising:
acquiring a communication message; and
determining whether the communication message is a normal message on the basis of a periodicity requirement set for each time-varying state of the communication message,
wherein in the determining, the periodicity requirement of the communication message is identified on the basis of a state of the communication message classified according to a transition type which is a factor affecting a periodic error of the communication message and a plurality of transition conditions which is set for each transition type, and it is determined whether the communication message is a normal message.

9. A storage medium storing a malicious communication detection program for causing a computer to perform all of the processing according to claim 8.

10. A malicious communication detection method comprising:
acquiring a communication message; and
determining whether the communication message is a normal message on the basis of a periodicity requirement set for each time-varying state of the communication message,
wherein in the determining, the state of the communication message is identified on the basis of at least one of a bandwidth load, a transmission count, and a time interval, and it is determined whether the communication message is a normal message according to the periodicity requirement set for the identified state of the communication message.

11. A storage medium storing a malicious communication detection program for causing a computer to perform all of the processing according to claim 10.

12. A communication permission list generation method comprising:
analyzing a communication specification in which a specification of a normal communication message is defined;
generating a communication permission list which is used to detect a malicious communication message on the basis of an analysis result of the communication specification;
identifying, on the basis of actual communication data, a condition under which a variation occurs in a periodic error of a communication message contained in the communication data;
determining a normal period range for each condition; and
updating the communication permission list.

13. A storage medium storing a communication permission list generation program for causing a computer to perform all of the processing according to claim 12.
